(19) United States
(12) Patent Application Publication
(10) Pub. No.: US 2008/0256881 A1
(43) Pub. Date: Oct. 23, 2008

(54) DOOR FRAME EDGE PROTECTOR

(75) Inventors: James W. Lowry, Franklin, TN (US); Erik Rogers, Murfreesboro, TN (US)

Correspondence Address: CLAUSEN MILLER, P.C, SUITE 1600, 10S. LASALLE STREET, CHICAGO, IL, 60603, US

(73) Assignee: SONOCO DEVELOPMENT, INC., Hartsville, SC (US)

(21) Appl. No.: 12/105,433

(22) Filed: Apr. 18, 2008

Related U.S. Application Data
(60) Provisional application No. 60/913,004, filed on Apr. 20, 2007.

(51) Int. Cl. E06B 1/04

(52) U.S. Cl. 52/212; 52/211

(57) ABSTRACT

A guard for protecting a door frame is provided. The guard is a formed and cut paperboard tube comprising a longitudinal spine and two curvilinear, elongated, resilient side members attached to the spine. The side members terminate in free edges adapted to grip opposite sides of the door frame wall. Each side member further comprises a longitudinally disposed bead for enhanced impact resistance.

### BACKGROUND

1. Field of the Invention

This patent relates to a protective device for door frames. More particularly, this patent relates to a device for protecting door frames that can be installed prior to construction, renovation and moving, and then easily and quickly removed afterwards.

2. Description of the Related Art

During construction, renovation and moving operations key surfaces in a building can be subjected to abuse by workers and equipment moving in and around the building rooms. These surfaces, which include door frames, door edges and outer wall edges (i.e. outwardly projecting wall corners), are costly to repair and can often delay the completion of a building project. Protecting these surfaces can avoid costly repairs, reduce overall building costs and shorten building project time.

Several previous attempts to provide a protective device for door frames and the like are known. For example, Weller U.S. Pat. No. 4,768,320 describes a generally U-shaped door frame guard having a rigid outer shell and a soft inner shell. The guard has a generally rectangular central section (spine) and generally straight inwardly converging side members designed to grip a wall.

Freelove U.S. Pat. No. 5,203,130 describes a generally U-shaped extruded plastic door frame shield having flange-like cleats that oppose the door frame trim to hold the shield in place.

Raulerson et al. U.S. Pat. No. 5,737,878 describes a U-shaped door guard made from polymeric material and having side members that taper toward each other and can grip a doorway.

Hill U.S. Pat. No. 5,775,045 described a magnetic door frame guard to be used with metal door frames.

Wamsher U.S. Pat. No. 5,815,998 describes a resilient, U-shaped, door jamb protector comprising a high density plastic core sandwiched between soft plastic foam material.

Haldeman U.S. Pat. No. 6,357,187 describes a cardboard door frame protector that encloses the door frame without contacting it.

Hartley et al. U.S. Pat. No. 6,526,708 describes a guard that is attached to a door frame with a clamp.

Stradel U.S. Pat. No. 6,826,877 describes a guard for protecting a door frame having trim molding. The guard comprises a planar web (spine) and parallel side panels normal to the spine that flex toward each other. At least one of the side panels has an inwardly directed shoulder with a transverse flange that seats against a rear facing surface of the door trim molding.

Lovas U.S. Pat. No. 6,829,863 describes a guard that is attached to a door jamb via metal spring strips.

Mayes U.S. Patent Application Publication No. 2004/0088933 describes a C-shaped door trim guard having ridges for gripping the door trim.

It is an object of the present invention to provide an alternative means for protecting building surfaces, particularly door frames, that are vulnerable to abuse by workers and equipment.

Another object of the invention is to provide a protective device for building surfaces that does not require adhesive and is easy to install and remove.

Further and additional objects will appear from the description, accompanying drawings, and appended claims.

### SUMMARY OF THE INVENTION

The present invention is a guard for protecting a door frame from impacts caused by people and equipment. The guard is a formed and cut paperboard tube comprising a longitudinal spine and two curvilinear, elongated, resilient side members attached to the spine. Each side member terminates in a free edge running parallel to the spine. The free edges are adapted to grip opposite sides of the door frame or the wall when the guard is placed over the door frame. No tape or other means of securing is required. Each side member further comprises a longitudinally disposed bead for added impact resistance. The guard may be manufactured by winding paperboard into a hollow longitudinal tube, forming the tube into the desired curvilinear shape, and making a longitudinal cut along the tube.

### THE DRAWINGS

FIG. 1 is a perspective view of a door frame guard according to the present invention.

FIG. 2 is a top perspective view of the door frame guard of FIG. 1 shown protecting a door frame.

FIG. 3 is a side plan view of the door frame guard of FIG. 1 shown protecting a door frame.

FIG. 4 is a close up perspective view of the door frame guard of FIG. 1 shown protecting a door frame.

FIG. 5 is a cross sectional view of the door frame guard of FIG. 1.

FIG. 6 is a cross sectional view of the door frame guard of FIG. 1 shown installed over a door frame.

### DETAILED DESCRIPTION OF THE INVENTION

While this invention may be embodied in many forms, there is shown in the drawings and will herein be described in detail one or more embodiments, with the understanding that this disclosure is to be considered an exemplification of the principles of the invention and is not intended to limit the invention to the illustrated embodiments.

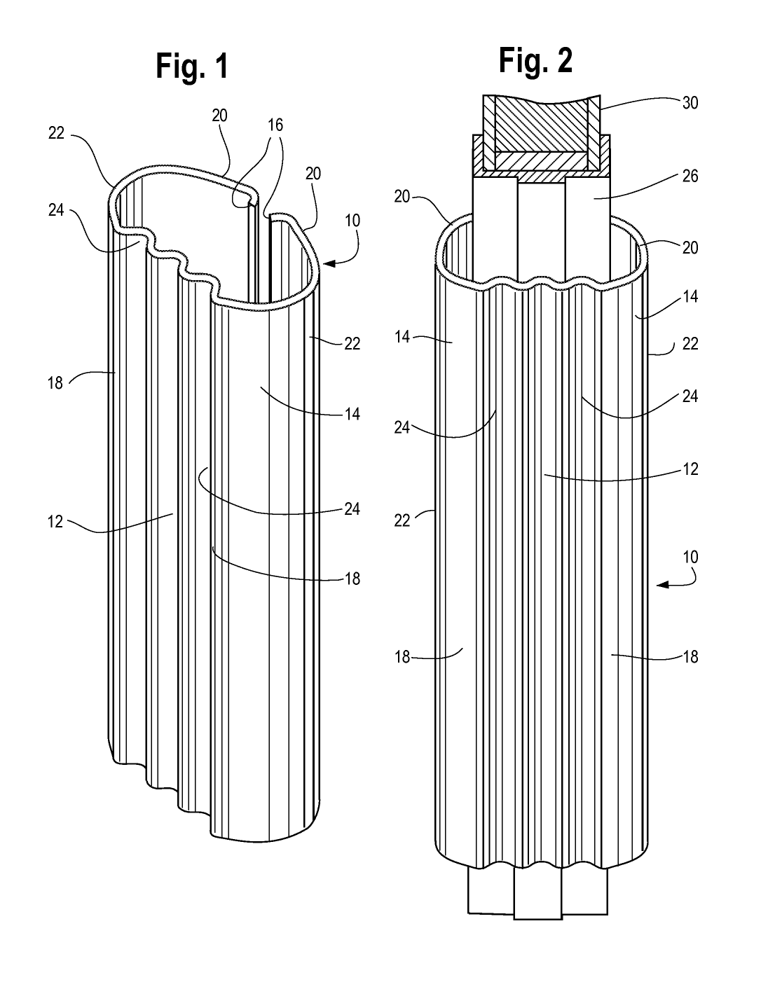

Turning to the drawings, there is shown in FIG. 1 one embodiment of the present invention, a guard 10 for protecting door frames and other building surfaces. The guard 10 comprises a longitudinal spine 12 and two opposing, substantially U-shaped, curvilinear, elongated, resilient side members 14 connected to each other along the spine 12. Each side member 14 terminates in a longitudinal free edge 16 that is substantially parallel to the spine 12. The resilient nature of the guard 10 causes the side members 14 to be biased toward each other when the side members 14 are flexed outwardly (away from each other).

More particularly, each U-shaped side member 14 comprises an outer wall segment 18 and an inner wall segment 20 connected at an outer apex 22. The inner wall segment 20 extends from the outer apex 22 to the free edge 16. The outer wall segment extends from the outer apex 22 to the spine 12.

Optional beads 24 may be longitudinally disposed in each outer wall segment 18 for added impact resistance and to enhance the spring-like characteristics of the guard 10. The spine 12 itself may be curved inwardly—in the direction of the inner wall segments 20—to further enhance the spring-like characteristics of the guard 10.

In its relaxed, unstressed condition, the distance (D) between the free edges 16 of the guard 10 preferably is less than the thickness of the wall to which the door frame is mounted. Consequently, when installing the guard 10 around a door frame affixed to a wall having a thickness greater than (D), the side members 14 must be flexed outwardly, away from each other. This is typically done by hand. When released, the free edges 16 grip either side of the wall 20 to hold the guard 10 in place without the need for further securing means.

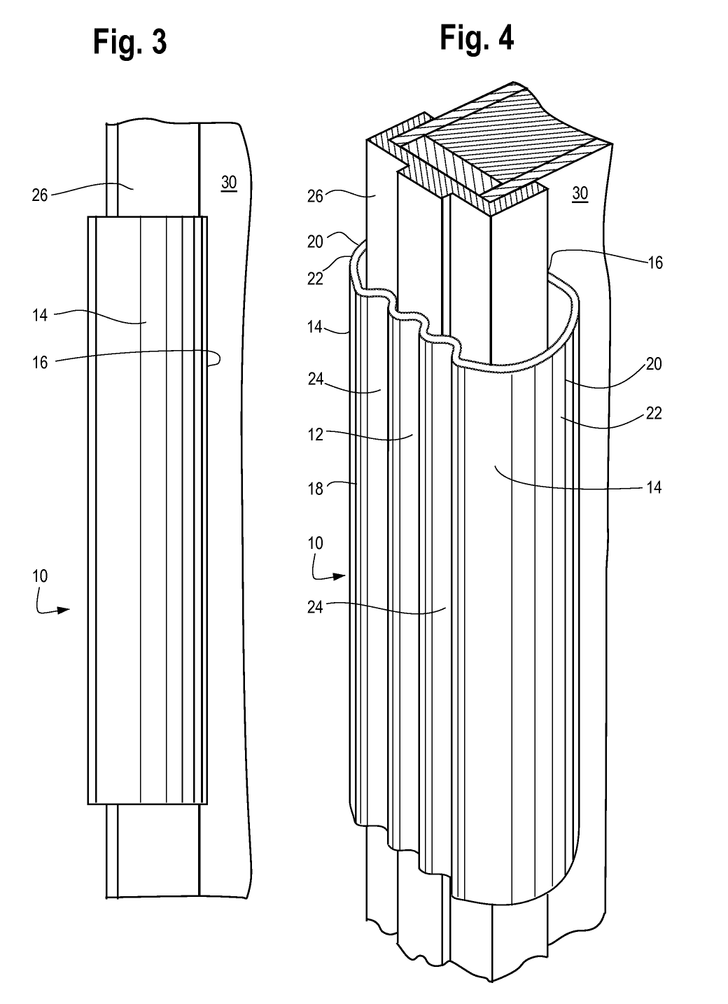

FIGS. 2-4 are views of a guard 10 shown installed over a door frame 26. When the guard 10 is placed over the door frame 26 to cover and protect it, the side members 14 are in a stressed, spread apart, state. The guard 10 covers the door frame 26 along its length, and preferably along that part of its length most likely to be subject to abuse from people and equipment.

Of course, the guard 10 can be made to any length to cover as much of the door frame 26 as desired. The guard 10 may be made wide enough and resilient enough to accommodate various door frame and wall thicknesses.

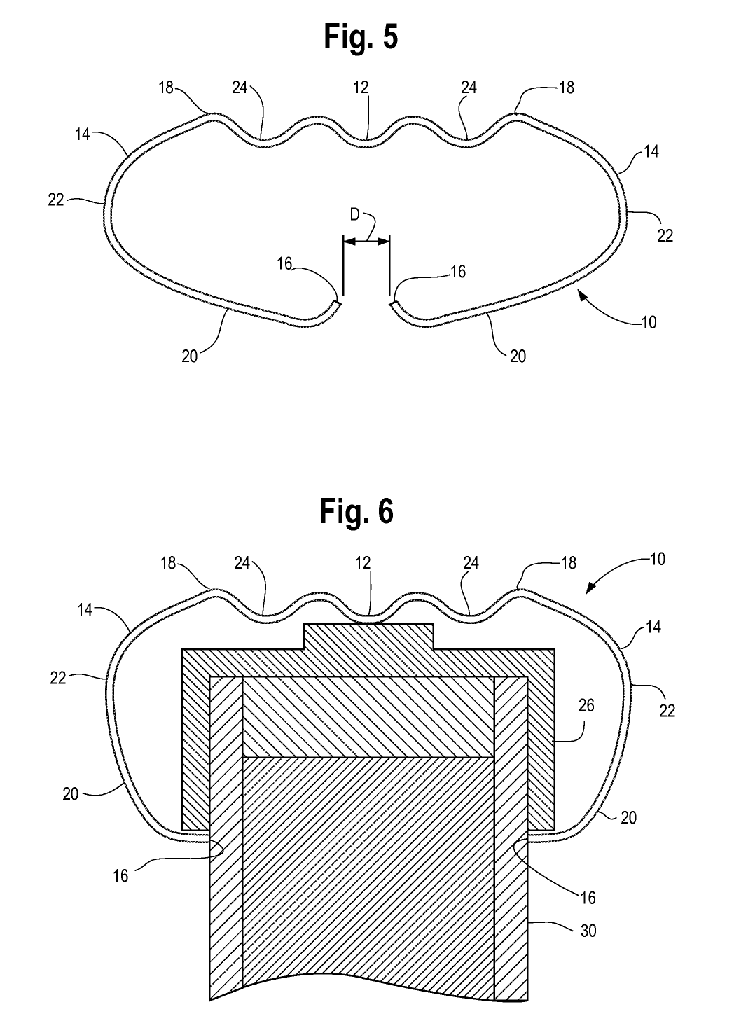

FIG. 5 is a cross sectional view of an edge guard 10 according to the present invention showing the distance (D) between the free edges when the guard 10 is in an unstressed position. The side members 14 are generally U-shaped and are connected at the inwardly curved spine 12. The outer and inner wall segments 18, 20 of each side member 14 meet at an outer apex 22.

FIG. 6 is a cross sectional view of the edge guard 10 of FIG. 5 shown installed over a door frame 26. The guard 10 is now in a stressed state and the free edges 16 are spread apart a distance greater than (D). The free edges 16 are in contact with the wall 30.

The guard 10 may be made from any suitable material, including plastic or metal, but preferably is made from paper or, more specifically, layers of paperboard laminated together.

The guard 10 may be manufactured by winding paperboard into a hollow tube, forming the tube into the desired curvilinear shape, and then making a longitudinal cut along the tube opposite the spine 12.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

We claim as our invention:

1. A guard for protecting a door frame affixed to a wall, the guard comprising:
a longitudinal spine; and
two curvilinear, elongated, resilient side members attached to the spine, each side member terminating in a free edge running parallel to the spine, the free edges adapted to engage opposite sides of the door frame or wall when the guard is placed over the door frame, each side member further comprising a longitudinally disposed bead.

2. The guard of claim 1 wherein the spine is curved inwardly.

3. The guard of claim 1 wherein the guard is formed from paper.

4. The guard of claim 1 wherein the guard is formed a plurality of layers of paperboard laminated together.

5. A guard for protecting a door frame affixed to a wall, the guard manufactured by:
winding paperboard into a hollow longitudinal tube,
forming the tube into the desired curvilinear shape; and
making a longitudinal cut along the tube.

6. The guard of claim 5 wherein the forming step comprises forming two opposing, curvilinear, elongated, resilient side members having a longitudinally disposed bead.

7. A guard for protecting a door frame affixed to a wall, the guard comprising:
a longitudinal, inwardly curved, spine; and
two opposing, substantially U-shaped, curvilinear, elongated, resilient side members attached to the spine, each side member terminating in a free edge running parallel to the spine, the free edges adapted to engage opposite sides of the door frame or wall when the guard is placed over the door frame, each side member further comprising a longitudinally disposed bead;
wherein the guard is formed a plurality of layers of paperboard laminated together; and
wherein the guard can be cut to a desired length.
